(19) United States
(12) Patent Application Publication
(10) Pub. No.: US 2012/0249277 A1
(43) Pub. Date: Oct. 4, 2012

(54) TAP CHANGER WITH A POLARITY SWITCH FOR A VARIABLE TRANSFORMER

(76) Inventors: Axel Kraemer, Regensburg (DE); Dazhong Shen, Neutraubling (DE)

(21) Appl. No.: 13/497,089

(22) PCT Filed: Nov. 2, 2010
(86) PCT No.: PCT/EP10/06665

§ 371 Date: Apr. 18, 2012

(30) Foreign Application Priority Data
Dec. 23, 2009 (DE) 10 2009 060 132.5

(51) Int. Cl. H01F 29/04

(52) U.S. Cl. 336/145

(57) ABSTRACT

The invention relates to a step switch provided with a pre-selector and a polarity circuit, a separate polarisation resistance being respectively provided at the beginning and the end of the stepped winding. Optionally, the two polarisation resistances can be connected continuously or via separate polarity switches.

The invention relates to a tap changer, which is provided with a preselector, with a polarity circuit for uninterrupted regulation at a regulating transformer.

DE 19 42 567 [GB 1,267,284] describes a tap changer with a preselector for selectable serial connection of taps of the tap windings with the associated main winding of a tapped transformer, in which the reversing contacts of the tap changer are constructed as changeover contacts.

In such tap changers the tap winding of the corresponding tapped transformer is briefly electrically separated from the main winding during actuation of the preselector. In that case it adopts a potential that results from the voltages of the adjacent windings as well as the coupling capacitances with respect to these windings or to earthed components. The thus-arising difference voltages load the switching path of the opening preselector contacts and can have the consequence of, inter alia, unacceptable discharge phenomena at the preselector. In order to avoid this it is known to briefly connect the center of the tap winding via a polarity resistance with a fixed point of the main winding, frequently the star point of the transformer, by means of a polarity switch during the switching-over phase and thus couple the tap winding to a defined potential.

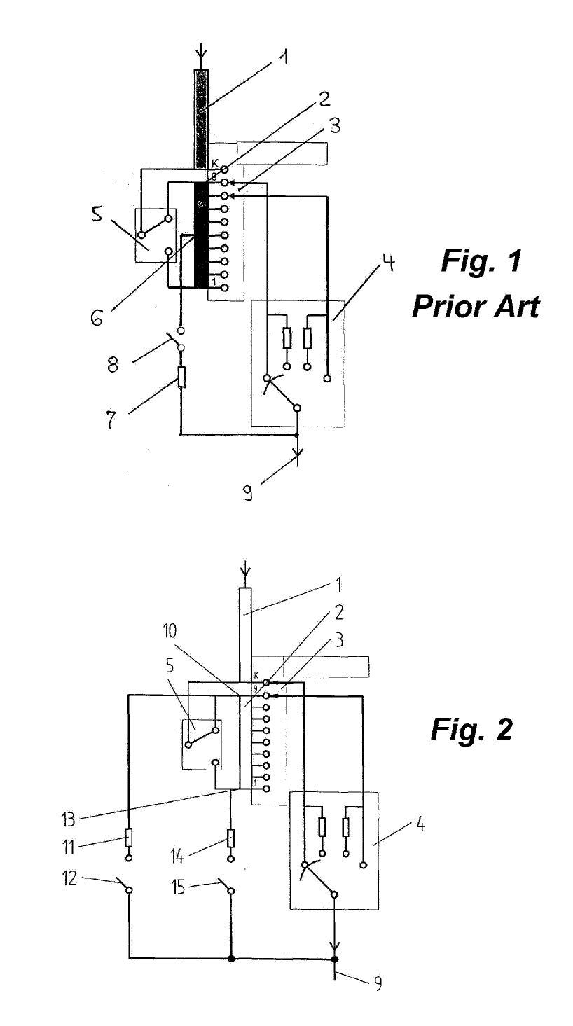

DE 32 24 860 A describes a similar arrangement at a tap changer, in which—shown there in FIG. 1b—a polarity resistance is, similarly again, connected with the center of the tap winding.

DE 195 42 880 C1 shows a polarity switch particularly suitable for such a transient connection of the center of the tap winding.

It is known from JP 55-133515 A and DD 47965 B1 to arrange at a tap changer, which is provided with a preselector and has a polarity circuit for uninterrupted regulation at a regulating transformer by way of the regulating winding, voltage-dependent resistances for protection against over-voltages during switching of the preselector.

DE 24 21 728 A1 describes a tap changer, which is provided with a preselector, with a polarity circuit, wherein by way of the regulating winding voltage-dependent resistances are arranged in combination with oil spark paths for protection against over-voltages during switching of the preselector.

Finally, it is already known from DE 11 65 154 [GB 2,045,612] to connect, in a tap changer provided with a preselector, the center tap of the regulating winding with the load shunt by way of a voltage-dependent resistance for protection against over-voltages during switching of the preselector and to provide voltage-dependent resistances in parallel with the connections of the regulating winding.

In general, the prior art with respect to tap changers, which are provided with preselectors, with a polarity circuit can be summarized as follows: a polarity resistance is provided between the center of the tap winding and the load shunt, which is connected—constantly or transiently only during the switching-over—with the load shunt by means of a polarity switch before the start of the preselector actuation. The tap winding is thereby coupled with a defined potential during the preselector switching.

It is disadvantageous with these known solutions that due to this polarity switching by the preselector the undesired capacitive current is switched, i.e. interrupted; arcs are then inevitable. These arcs cause formation of gas. This is undesirable for numerous applications, for example in the case of ultra-high-voltage applications. These undesired gases are increasingly disruptive with increasing system voltage.

It is accordingly the object of the invention to provide a tap changer with an improved polarity circuit that is accompanied is by significantly reduced formation of arcs at the preselector.

This object is fulfilled by a tap changer of the kind stated in the introduction with the features of the parallel patent claims 1 and 2.

The general inventive concept, which applies to both forms of embodiment in the parallel claims, consists of providing two separate polarity resistances that are connected with the start and the end of the tap winding.

The significant advantage of the two forms of embodiment of the invention consists in that the two polarity resistances provided in accordance with the invention form a bypass for the capacitive current; the capacitive current commutates from one side to the other side and in departure from the prior art it does not have to be switched off, i.e. interrupted, by the preselector. As a consequence, a significantly lower degree of arc formation arises.

The invention is explained in more detail in the following by way of drawings, in which:

FIG. 1 shows an arrangement according to the prior art;

FIG. 2 shows a first form of embodiment of the invention according to patent claim 1; and

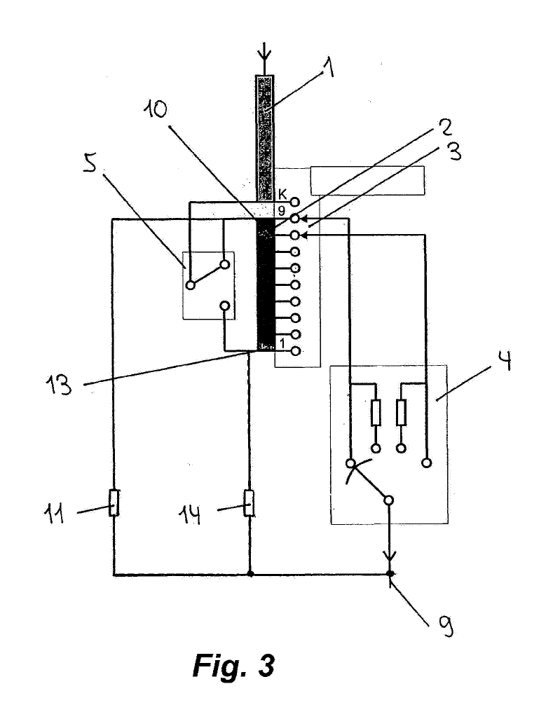

FIG. 3 shows a second form of embodiment of the invention according to patent claim 2.

Initially, a prior art polarity arrangement shall be explained again by way of FIG. 1. A main winding 1 and a tap winding 2 of a tapped transformer are shown. A tap changer, which has a selector 3, is connected with the tap winding 2. The selector 3 before a switching-over process initially preselects, free of power, the new winding tap of the tap winding 2, which is to be switched over to. The switching-over itself is carried out by a known load changeover switch 4 of the tap changer, which does not need to be discussed here in more detail. In addition, the tap changer comprises a preselector 5 by which, for increasing the regulating range at the start or end of the tap winding 2, can be connected with the end of the main winding 1. The actual polarity circuit consists of a polarity resistance 7 that is coupled with the center 6 of the tap winding 2 and is connected either directly with the load shunt 9 or, as shown here, only transiently with the load shunt 9 by way of a polarity switch 8.

The constant coupling of the polarity resistance 7—although it is needed only during the switching-over—causes additional transformer losses, for which reason in most cases a polarity switch 8 is inserted in the polarity circuit.

FIG. 2 shows a first form of embodiment of the invention; the same components are provided with the same reference numerals. In departure from the prior art, according to the invention provided at the start 10 of the tap winding 2 is a first polarity resistance 11 that is connected with the load shunt by means of a first polarity switch 12. In addition, in accordance with the invention a second polarity resistance 14, which is connected again with the load shunt 9 by way of a second polarity switch 15, is provided at the end 13 of the tap winding 2. The two polarity switches 12, 15 are switched on only briefly before the start of actuation of the preselector 5, so that the start 10 and end 13 of the tap winding 2 are coupled to a defined potential only temporarily.

FIG. 3 shows a second form of embodiment of the invention in which no polarity switches are provided. Rather, here a first polarity resistance 11 is coupled fixedly and permanently to the start of the tap winding 2 and a second polarity switch 14 is coupled fixedly and permanently to the end 13 of the tap winding 2. In this form of embodiment of the invention the mechanical outlay is less, since, as explained, separate polarity switches are omitted; on the other hand, the disadvantageous higher losses due to permanent connecting-in of the polarity resistances 11, 14 have to be accepted.

Ultimately, a decision on which of the two variants is a matter of discretion within the scope of the invention. Both forms of embodiments can be realized in single-phase tap changers without substantial effort.

In particularly advantageous manner, in both forms of embodiment the polarity resistances 11, 14 can be of asymmetrical design so that the specific polarity conditions at respective transformers can be adjusted or made comparable in simple manner.

1. A tap changer that is provided with a preselector, with a polarity circuit for uninterrupted regulation at a regulating transformer, wherein the regulating transformer comprises one or more main windings and a tap winding, wherein the tap changer is switchable between different winding taps of a tap winding, which are each connectable with a load shunt, and wherein a polarity circuit is provided in such a manner that the tap winding during switching over from one winding tap to another winding tap is connectable with the load shunt, wherein provided at the start of the tap winding is a first polarity resistance that is connected with the load shunt by way of a first polarity switch and that provided at the end of the tap winding is a second polarity resistance that in turn is connected with the load shunt by way of a second polarity switch.

2. A tap changer that is provided with a preselector, with a polarity circuit for uninterrupted regulation at a regulating transformer, wherein the regulating transformer comprises one or more main windings and a tap winding, wherein the tap changer is switchable between different winding taps of a tap winding, which are each connectable with a load shunt, and wherein a polarity circuit is provided in such a manner that the tap winding during switching over from one winding tap to another winding tap is connectable with the load shunt, wherein provided at the start of the tap winding is a first polarity resistance that is connected with the load shunt and that provided at the end of the tap winding is a second polarity resistance that in turn is connected with the load shunt.

3. The tap changer according to claim 2, wherein the two polarity resistances have different electrical values.

4. The tap changer according to claim 1, wherein the two polarity resistances have different electrical values.
